(19) United States
(12) Patent Application Publication
(10) Pub. No.: US 2004/0034826 A1
(43) Pub. Date: Feb. 19, 2004

(54) Transport protocol checksum recalculation

(76) Inventor: Johan Johansson, Sundbyberg (SE)

Correspondence Address: NIXON & VANDERHYE, PC, 1100 N GLEBE ROAD, 8TH FLOOR, ARLINGTON, VA, 22201-4714, US

(21) Appl. No.: 10/362,578

(22) PCT Filed: Sep. 12, 2001
(86) PCT No.: PCT/SE01/01943

(30) Foreign Application Priority Data
Sep. 13, 2000 (SE) 0003242-5

(51) Int. Cl. H04L 12/28

(52) U.S. Cl. 714/752; 370/351

(57) ABSTRACT

The present invention relates to a method, a system and a computer program product for transmission of data in a media stream from a sender to a receiver using a data transmitting protocol where it comprises the steps of, transmitting packets from the sender in a format corresponding to the protocol used, receiving the packets at the receiver, calculating the checksum of each received packet according to the scheme for calculating checksum specific for the protocol used and inserting the calculated checksum in a header of the packet.

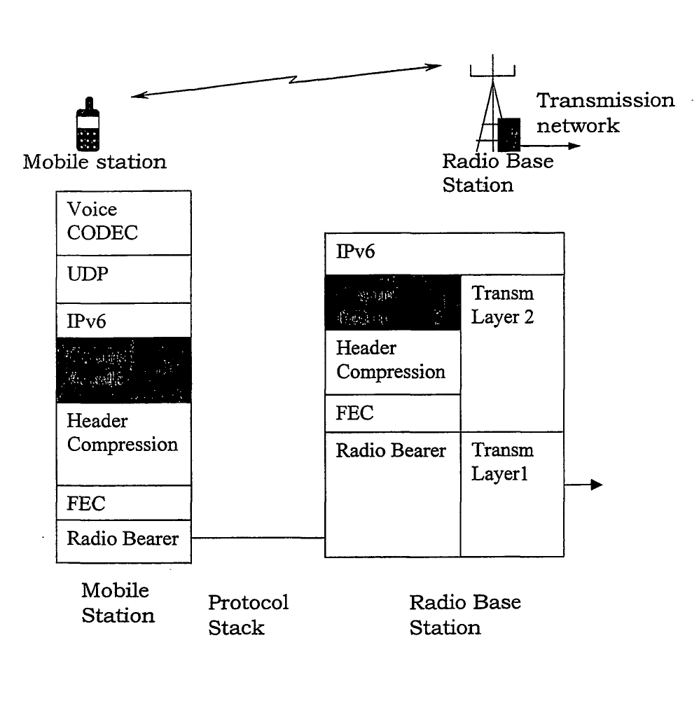

### TECHNICAL FIELD

The invention relates to protocol and network functionality where errors in data are acceptable to applications, where there are high-bit-error links that are the sources of those errors and where the protocol suites prohibits delivery of damaged data.

For example, it relates to the area of media streams such as voice, transported over high-bit-error radio links using a protocol.

### BACKGROUND OF THE INVENTION

There are a number of protocols used, which have different properties as regards efficiency and reliability. One set of protocols is the TCP/IP suite which comprises protocols such as TCP and UDP.

As an example, a UDP/IP (User Datagram Protocol/Internet Protocol) packet header has several well-defined IP fields, such as a version field, a header length field, a type of service field, a total length field, a packet identification field, a flag field, a fragment field, a time to live field, a protocol field, a header checksum field, a source IP address field, and a destination IP address field, and several well-defined UDP fields, such as a source port number field, a destination port number field, a UDP length field, and a UDP checksum field. Some of these fields do not change from packet to packet, rather only a subset of the fields changes. As can be seen, the UDP transport protocol implements checksumming, the header checksum filed, and prohibits data that have been damaged when transported. Not only the damaged bit/byte is discarded, but a whole packet.

One way to take care of this problem is to introduce Forward error Correction (FEC) for high-bit-error links, that removes all/almost all bit errors. Document U.S. Pat. No. 5,870,412 discloses a Forward Error Correction System for packet based real time media. The system is based on appending a single forward error correction code to each of a series of payload packets, which code is defined by taking the XOR sum of a preceding specified number of payload packets. The main objective with the system is to enable correction from the loss of multiple packets in a row without significant increase of data rate or delay of transmission.

However, if forward error correction would be used to take care of all bit errors, it would expand the needed bandwidth beyond what is economically reasonable for most radio links. There may also be a significant amount of errors left even after applying FEC.

Another way to take care of this problem would be to introduce a link protocol for high-bit-error links, that retransmits damaged packets and delivers all packets correctly. This would however add to the transmission delay, which would significantly decrease perceived quality for conversational media stream services. The transmission delay is high, because radio links are in general adapted to narrow band speech channels. The narrow band width limits the transmission capacity and in order not to loose timing of the packets transmitted, a buffering is needed when retransmitting due to an error, which increases the delay.

Today, for cellular radio links, protocols such as UDP are not widely used for conversational voice services. Instead, voice transport specific protocols are used, in e,g, GSM networks. However, when introducing new media stream services it is expected that the standard application programmers interface (API) to such services will be the TCP/IP protocol suite API, which can not be used with today's voice transport specific protocols.

For UDP in IPv4 checksumming can be disabled. However for UDP in IPv6 checksumming can not be disabled. Changing the standards would be one way to solve the problems. However, in this case it might not be an option to change the standards.

In many media streaming applications, such as voice, the applications themselves (codecs) can handle errors in the data, and for most such applications, the perceived quality of the media stream would be better if damaged packets are delivered to the media stream application.

### BRIEF DESCRIPTION OF THE INVENTION

The object of the present invention is to remedy the above mentioned problems and to obtain a high degree of protocol and network functionality even with high-bit-error links that would not delay the transmission and/or expand the bandwidth unnecessarily.

This object is solved according to one aspect of the invention with a method of recalculating the transport protocol checksum in a network node (a kind of gateway) and/or the end-node, when receiving a packet that has crossed a high-bit-error link, and insert the new checksum in the checksum header field of the packet. This would be done for any or all media streams for which this is appropriate, e.g. conversational streams where the application is known to handle damaged data.

Preferably the transmitted packets are treated with header compression, which is known per se, in order to reduce the size of the packets.

Further, if header compression is used with the present invention, the header of each packet is not transmitted but reconstructed by the sender.

With the present invention, it is possible to transmit damaged data without the delay caused by retransmission and the like operations, or risking loss of whole data packets. It provides a reduced data size and reduced data processing since much of the information comprised in the headers of the packets, including checksum, no longer need to be transmitted, thus enhancing the perceived quality of the media stream for many applications.

These and other aspects of, and advantages with, the present invention will become apparent from the following detailed description of an embodiment of the invention and from the accompanying drawing.

### DETAILED DESCRIPTION OF THE INVENTION

The present invention relates to communication networks and in particular to IP networks, e.g. IPv6 networks, and the communication over narrow band width cellular radio links such as shown in the FIGURE.

For any low bandwidth link that uses high overhead protocols such as IPv6, it can be expected that Header compression is used [Degermark, van Jacobsen, ROCCO], although this is not a necessity for the present invention. The Jacobson technique provides an elaborate and complex compression scheme that reduces an up to 40-byte packet header to a three-byte compressed header. The compressed header has an encoded change to the packet ID, a checksum, a connection number, and a change mask. The hardware and/or software used to implement the Jacobson technique must perform sophisticated computations that compress the header and then subsequently decompress the compressed header to reproduce the uncompressed header.

The packet header compressor forms a compressed header from the fields of an associated uncompressed header. The compressed header contains one or more fields, which are subject to change from packet-to-packet, but not all of the fields in a normal uncompressed header. The fields that are common to both the compressed and uncompressed headers are otherwise identical. Compression is achieved by removing the non-changing header fields from the compressed header. For instance, in the case of compressing a UDP/IP header, the packet header compressor might form a compressed header having only the packet identification field, the flag field, and the fragment field, which change from packet to packet, while omitting the other IP and UDP fields.

With the header compression technique, a full packet header is only sent in the beginning of a session, or when the receiver finds it necessary. Instead, a connection number is sent, indicating to the receiver which session a particular packet belongs to. Also, header fields that change for each packet in an unpredictable way, such as checksums, are sent for each packet. From this information, the receiver can deduce the original packet and its full header, and deliver it to the UDP/IPv6 protocol layer.

If an error would occur in a transmission link, the checksums would be transferred without modification by the header compression layer and the IPv6 would discard damaged packets.

Therefore, with the present invention, if the checksum transmitted with a packet, for example from a mobile station, does not correspond to the checksum calculated at the receiving end, for example a radio base station, ie an error has occurred during the transfer, the checksum is recalculated in a network node (a kind of a gateway) and/or end node, according to a conventional algorithm for calculating a checksum for that particular protocol in order to obtain a value on the checksum, which is then inserted in the header. Although the recalculated value of the checksum may not, or may, be the transmitted value, the present invention prevents the protocol to unnecessarily drop damaged packages by recalculating a new checksum, thereby enhancing the perceived quality of a media stream, especially since many media streaming applications themselves can handle errors in data. Further, with the present invention it is possible to make use of such protocols as UDP without changing the protocols.

Except for the gateway and/or end user that performs the checksum recalculation and insertion, the whole protocol infrastructure can be kept intact.

Checksum recalculation may be done in the header compression layer or in its own layer, as indicated in the FIGURE.

In many ways, checksum recalculation, may be regarded to be yet another feature of header compression. Header compression algorithms reconstruct headers from incomplete data in compressed packets and from state data from earlier packets. Checksum recalculation according to the present invention reconstructs the checksum part in the header from other data in the packet and from the uncompressed header.

In IPv6, the purpose of the transport checksum is also to protect the packet header, which is particularly sensitive to errors. For example, in IPv4, the header has its own checksum. However, when checksum recalculation is used together with header compression, the header is actually never sent, it is reconstructed by the header compression layer of the receiver. Thus, only the data part of a packet can be damaged on the high-bit-error link when using checksum recalculation with header compression.

The contents of the packet header is not jeopardised. Actually, when checksum recalculation is used, it is possible to further enhance the header compression algorithm by excluding transmission of the checksum. This is an additional advantage with the present invention since checksum generation is a large portion of the processing required for passing message data over a network. Computation of the Internet checksum by the sender and by the receiver for every message packet transferred over a network incurs undesirable overhead, thereby reducing the overall speed of communications within the network. This further indicates that checksum recalculation should be regarded a feature of header compression.

It is to be understood that the embodiment described above and shown in the drawing is to be regarded as a non-limiting example of the present invention and that it may be modified within the scope of protection defined by the patent claims.

1. Method for transmission of data in a media stream from a sender to a receiver using a data transmitting protocol, comprising the steps of, transmitting packets from the sender in a format corresponding to the protocol used, receiving the packets at the receiver, calculating the checksum of each received packet according to the scheme for calculating checksum specific for the protocol used and inserting the calculated checksum in a header of the packet.

2. Method according to claim 1, wherein it comprises the further step of compressing the header of each packet at the sender.

3. Method according to claim 2, wherein it comprises the further step of excluding the transmitting of the header with the packets and reconstructing the header by the receiver.

4. Method according to any of the preceding claims, wherein the protocol used is a TCP/IP-suite protocol.

5. Method according to any of the preceding claims, wherein the sender and receiver is part of an internet version 6 network.

6. System for transmission of data in a media stream, comprising
a sender capable of transmitting packets in a format corresponding to a data transmitting protocol used,
a receiver capable of receiving the transmitted packets,
calculating means capable of calculating the checksum of each received packet according to the scheme for calculating checksum specific for the protocol used and inserting the calculated checksum in a header of the packet.

7. System according to claim 6, wherein the sender comprises means or compressing the header of each packet.

8. Computer program product comprising computer code means and/or software code portions for making a computer or processor perform the steps of:
receiving packets transmitted from a sender in a format corresponding to the protocol used,
calculating the checksum of each received packet according to the scheme for calculating checksum specific for the protocol used, and
inserting the calculated checksum in a header of the packet.
